(19) United States
(12) Patent Application Publication
(10) Pub. No.: US 2002/0182520 A1
(43) Pub. Date: Dec. 5, 2002

(54) Image recording material and method for producing the same

(75) Inventor: Kaoru Torikoshi, Minamiashigara-shi (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 09/998,340

(22) Filed: Dec. 3, 2001

(30) Foreign Application Priority Data
Mar. 19, 2001 (JP) 2001-79522
Sep. 20, 2001 (JP) 2001-287296

(51) Int. Cl. G03G 13/00

(52) U.S. Cl. 430/18; 430/97

(57) ABSTRACT

An image recording material on which an image can be formed by electrophotography, and a method for producing the same. The material comprises a substrate having transparency, an image being formable by an electrophotography system on one side of the substrate, and a characteristic controlling member which is provided at a side of the substrate which is opposite to the side where the image is formed. The image is printed as a mirror image which can be viewed through the substrate. The characteristic controlling member can be provided with functions such as heat resistance, light resistance, glossiness adjustment and the like. Thus, an image of high quality having sufficient heat resistance and light resistance and good visibility, even for outdoor use, can be formed, and manufacture thereof is easy.

### BACKGROUND OF THE PRESENT INVENTION

1. Field of the Present Invention

The present invention relates to an image recording material on which an image is formed (recorded) by an image forming apparatus of an electrophotography system and also to a method for manufacturing the material.

2. Description of the Related Art

Together with progress in image forming techniques in recent years, it has been known that images of the same quality can be formed in large amounts and at low cost by means of various printing methods such as intaglio printing, anastatic printing, lithographic printing, gravure printing and screen printing. Among them, screen printing is able to print a printed matter (merchandize) having a high degree of design such as meter panel for automobiles, various kinds of labels, clockface, outdoor advertisement, poster, scarf, etc. Such printed matters may be used not only in common interior (office environment) but also in open air and, therefore, it is desirable that their heat resistance to the temperature of around 100° C. and light resistance to sunbeam (mostly, ultraviolet ray) are high. Accordingly, when the printed matter used in open air is formed by means of a screen printing, there is selected and used an ink of a pigment type having excellent heat resistance and light resistance giving no deterioration in the image quality when exposed for several hundred hours at the temperature of around 100° C. or for several hundred hours by a light-resistance tester such as a sunshine meter or a fade meter with an assumption of being exposed to ultraviolet ray or sunbeam.

In a screen printing, many printing plates corresponding to the numbers of pictures to be printed are necessary and, in the case of color printing, further numbers of printing plates corresponding to the colors are necessary. Especially in the case of a printed matter having a high degree of design as mentioned above, it is often that many different things in a small amount are necessary (production of many types each being in small quantities) or, whenever the shape is changed, a new printing plate is to be prepared and, in order to cope with the changes in the production amount, the printing plate is to be changed for each time and thus many types and kinds of printing plates in large quantities are required. Therefore, in the case of preparation of a printed matter having a high degree of design by means of a screen printing, there is a problem that much labor and time are needed for storage and control of a lot of printing plates.

Further, in a screen printing step, an organic solvent or the like is contained in the ink and, therefore, it is necessary to pay attention not only for effects on the human body but also for environmental pollution. In addition, much energy and drying time are needed for drying such an organic solvent and that is a cause for lowering the productivity. Moreover, it is necessary to wash the printing plate for a repeated utilization of the printing plate and a lot of organic solvent is necessary for such a washing as well. When a printing plate is exchanged, it is also necessary to exchange a screen printing head which is stained by the ink used before and, for cleaning the head, additional time for its exchange is necessary which causes further lowering of the productivity.

In contrast, in the case of an image formation (printing) by means of an electrophotography system, there is used a method where surface of an image carrier is uniformly charged and exposed to light corresponding to the image signal so that an electrostatic latent image due to the potential difference between exposed and non-exposed parts is formed and, after that, color powder (an image forming material) which is called a toner having an opposite polarity to the above charge is subjected to an electrostatic developing and thus a visible image (toner image) is formed. In the case of a color image, such a step is repeated for several times to form a visible color image and it is transferred onto an image recording material and fixed (immobilized) and thus a color image is prepared.

As mentioned above, an electrostatic latent image on an image carrier is electrically formed by means of an image signal in the case of an electrophotography system and, therefore, the same image can be formed as many times as possible and, moreover, different image can be easily prepared as well. In addition, a toner image on an image carrier can be transferred to an image recording material almost completely and even a toner image which is slightly remained on the image carrier can be easily removed by a resin blade or a brush and thus it is possible to easily prepare a printed matter which is aimed to a production of many types each being in small quantities.

Typically, the above toner is formed in such a manner that thermofusing resin, pigment and, if necessary, additives such as a charge controlling agent are mixed and ground to make into fine particles. An electrostatic latent image in an electrophotography system has a sufficiently high resolving power as compared with finely ground toner and can be expected to have a sufficient resolving power even as compared with a resolving power in a screen printing.

A color toner has four elementary colors of cyan, magenta, yellow and black and, therefore, when they are mixed, the same color as in the printing can be theoretically reproduced. Further, toner resin and pigment can be compounded relatively easily in a color toner and, therefore, it is easy to increase an image masking by a toner. In addition, when the requested colors are few, an image masking property can be further improved by layering a toner of a single color.

Usually, an image recording material (printing paper) in an electrophotography system is in an assumption of being used under the common office environment at the temperature of around 10° C.-30° C. and the humidity of around 15%-85% and has been rarely investigated for its heat resistance and light resistance with an assumption of outdoor use. However, in output of color image by an electrophotography system, pigments having excellent light resistance in cyan, magenta, yellow and black have been utilized as a color toner and it is believed that light resistance of the image recording material in an electrophotography system can be well expected. Similarly, it is believed that, when a heat resistant toner is selected, heat resistance of an image recording material will become to such an extent that can be used in open air.

However, in the electrophotography system as mentioned above, sufficient fixing temperature and pressure are applied by a fixing roller during a fixing step and, as a result, toner is well fused and there is prepared a (color) image of a high glossiness where the surface of the image is made flat. A color image with a high glossiness gives an excellent image quality in, for example, the case of a photographic image having a relatively high image density but, on the other hand, there is a disadvantage in terms of visibility due to the fact that a “glittering” is noticeable because of a big difference of glossiness from the surface of the printing paper and that the degree of glossiness changes depending upon the visual angle.

For preventing the lowering of the visibility of the image depending upon the visual direction, there has been proposed a method where, in an electrophotography system, toner having a high fusing temperature is used and a fixing is carried out under the such a condition that the toner is not well fused and thus the surface glossiness of the image surface is lowered. However, when a toner is not well fused, a partially uneven fusion is apt to take place and, as a result, it is presumed that an uneven glossiness in the image (a phenomenon where glossiness is partially different) is apt to be generated and further that fixation of the toner to the image recording material becomes bad. Anyway, it is difficult to control the surface glossiness by means of a fixing condition.

In JP-A No. 9-171,266, it is proposed as a method for controlling a surface glossiness of image and a recording material that a porous coating solution comprising a porous resin is applied to an image receiving layer to form a porous coat on the surface of the image receiving layer so that the scattering on the surface is increased and thus the surface glossiness is lowered and, at the same time, toner is embedded into the porous coat and thus the glossiness of the image surface is made lower as well. However, according to the method, it is difficult to sufficiently lower the surface glossiness and, further since a sufficient amount of toner is necessary for improving the masking property of the image, there is a risk that the toner which is left unabsorbed with the porous coat increases the glossiness of the image surface.

There is also proposed a method for lowering the surface glossiness by means of a light scattering on the surface where the surface is made uneven by a process such as a sand blasting. However, in improving the uniformity of the surface glossiness, it is necessary to carry out a sand blasting under a strong condition and, as a result, there are problems that the surface glossiness lowers too much and that quality of the image lowers due to the formation of unevenness on the image forming surface.

Further, it has been known that, in forming a color image by an electrophotography system, a phenomenon where a color toner is fused onto a fixing roller (hot off-setting) is resulted. In order to prevent such a phenomenon, there has been carried out a means where a releasing agent such as silicone oil is impregnated, applied or added to a fixing roller. However, that causes not only lowering of an image quality such as lowering of writing property to image, poor adhesion of adhesive tape, worsening of quality feel by viscousness and lowering of permeability due to adhesion of the silicone oil to the image recording material but also lowering of abrasion strength of roll and they are the biggest problem in the fixing devices.

As a countermeasure for such problems, there has been proposed a method as a method for fixing without the use of oil (an oil-less fixing) using a toner (oil-less toner) where a toner resin is mixed with various kinds of releasing agents including an organic high-molecular wax such as polyethylene wax and polypropylene wax or a natural wax such as carnauba wax for the prevention of an off-setting.

However, in the case of a color coating paper or an OHP film for color image where an image receiving layer having a high affinity to the toner is coated on the substrate surface with an object of formation of good image and improvement of image preservability, whole area of the image recording material contacts the fixing roll and thus it is the current state that there are problems that the image recording material off-sets to the fixing roll and that a fixation without an fixing oil is not possible.

As such, when it is planned to give glossiness and other characteristics which are required for use in harsher environments to the image forming surface, control therefor is difficult due to reasons specific to imaging by an electrophotography system. This is also a problem in the case where other characteristics are desired of the image forming surface.

### SUMMARY OF THE PRESENT INVENTION

The present invention has been achieved for solving the above-mentioned problems and, in more detail, an object of the present invention is to provide an image recording material which can be manufactured easily and can form an image of high quality with good visibility and having sufficient heat resistance and light resistance even for outdoor use, and also to provide a method for manufacturing the same. An other object of the present invention is to provide an image recording material having characteristics suitable for application in various usage environments and a method for manufacturing the same. Still another object of the present invention is to provide an image recording material where no off-set phenomenon results even when oil-less toner is used and a method for manufacturing the same.

In order to achieve the above-mentioned objects, the present inventors have carried out intensive study and, as a result, have devised an image recording material having a characteristic controlling member in which an image mirror is formed on the surface of a substrate having transparency. Thus, the image can been recognized as an orthographic image (normal image) when the image is seen by eye through the substrate. Further, the characteristic controlling member provides various functions such as control of glossiness to the surface where the image is not formed.

The present invention discloses an image recording material comprising a substrate having transparency, an image being formable by an electrophotography system on one side of the substrate, and a characteristic controlling member which is provided at a side of the substrate which is opposite to the side where the image is formed.

In another embodiment, the present invention is the above image recording material wherein the characteristic controlling member includes a glossiness controlling layer which controls glossiness of the other surface.

In still another embodiment, the present invention is the above image recording material wherein the glossiness controlling layer contains resin and filler.

In a further embodiment, the present invention is the above image recording material wherein the characteristic controlling member is provided at the surface of the substrate by a mechanical treatment which controls glossiness.

In a still further embodiment, the present invention is the above image recording material wherein the characteristic controlling member includes a light resistance control layer which controls light resistance.

In yet another embodiment, the present invention is the above image recording material wherein the light resistance controlling layer contains at least one material selected from the group consisting of ultraviolet absorbers, antioxidants, and pigments and dyes that have an absorption wavelength in the visible region.

In a yet further embodiment, the present invention is the above image recording material wherein the characteristic controlling member includes a heat resistance controlling layer which controls heat resistance.

In still another embodiment, the present invention is the above image recording material wherein the heat resistance controlling layer contains at least a heat resistant resin.

In yet another embodiment, the present invention is the above image recording material wherein the characteristic controlling member includes a flame retardation controlling layer which controls flame retardation.

In another further embodiment, the present invention is the above image recording material wherein the flame retardation controlling layer contains resin and flame retardant.

In a still further embodiment, the present invention is the above image recording material wherein the image is formed on an image receiving layer provided on the substrate.

In a yet further embodiment, the present invention is a method for producing the above image recording material, the method including the steps of: (a) providing a substantially transparent substrate including opposing surfaces, one surface of which is for image formation by electrophotography; (b) forming a layer on the other surface for controlling characteristics of an image to be formed on the one surface, as viewed through the substrate; (c) forming an image on the one surface for viewing through the substrate; and (d) mounting the substrate with the other surface disposed for displaying the image.

### BRIEF DESCRIPTION OF THE DRAWING

FIG. 1 is a schematic oblique view for illustrating an image recording material which is an embodiment of the present invention.

### DETAILED DESCRIPTION OF THE PREFERRED EMBODIMENTS

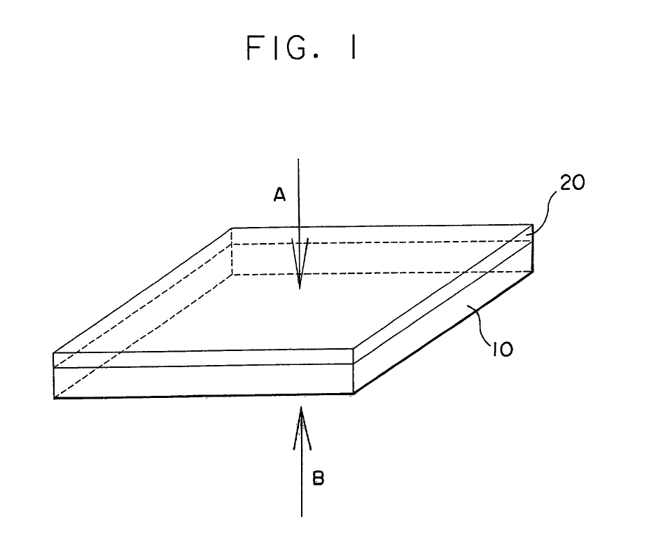

An example of the embodiments of the present invention will be illustrated in detail hereunder by referring to the drawing. FIG. 1 is a schematic oblique view for illustrating an image recording material which is an embodiment of the present invention. As shown in FIG. 1, the image recording material having a substrate 10 and a characteristic controlling member 20. If necessary, it may be in such a constitution that an image receiving layer which is not shown here is further provided on the surface of the substrate 10 where the characteristic controlling member 20 is not formed. In FIG. 1, the characteristic controlling member 20 is shown as that having no layered structure although the present invention is not limited to such a shape but a characteristic controlling member 20 may be directly provided on the substrate 10 by a mechanical treatment of the surface of the substrate 10.

The image recording material of the present invention has such a structure that an inverted image (mirror image) is formed on the surface of the substrate having transparency and thus an image can be recognized as an orthographic image (normal image) when the image is seen by eye through the substrate and that a characteristic controlling member is provided on the surface where the inverted image is not formed. Thus, as shown in FIG. 1, an image is formed from the side of an arrow Δ while a characteristic controlling member 20 is provided on the surface shown by an arrow B. In accordance with such an image recording material, the surface where the image is formed (hereinafter, referred to as “image surface”) and the surface where the characteristic controlling member 20 is formed (hereinafter, referred to as “control surface”) are different and, therefore, various characteristics can be controlled without affecting the quality of the formed image.

It is essential that the substrate 10 which can be used in the image recording material of the present invention has transparency. Here, transparency means a property that light of a visible light region is transmitted to some extent and, in the present invention, the transparency is sufficient at least in such an extent that the formed image can be seen by eye through a substrate 10.

With regard to the substrate 10, plastic film is representatively used. Among that, acetate film, cellulose triacetate film, Nylon film, polyester film, polycarbonate film, polystyrene film, polyphenylene sulfide film, polypropylene film, polyimide film, Cellophane, etc. are available as a film having a light transmittance usable for an OHP (Over Hear Projector). At present, polyester film is much used from a generalized view of mechanical, electric, physical and chemical properties, processing ability, etc. and, particularly, a biaxially elongated polyethylene terephthalate film is much used.

With regard to the substrate 10, there may be used resin having transparency and ceramics having transparency in addition to the above-mentioned plastic film and pigment, dye, etc. may be further added thereto. The substrate 10 may be in a shape of film or plate or may be in a shape having a thickness of such an extent that the strength necessary for the demand as the substrate 10 is available.

The characteristic controlling member 20 is provided to give and/or improve various characteristics such as glossiness, light resistance, heat resistance, flame retardation, electric conductivity, moisture resistance, water repelling property, abrasion resistance and scratch resistance to the control surface of the substrate 10. As a result, the image recording material having the characteristic controlling member 20 is able to have resistances under various operating conditions. Accordingly, when the characteristic controlling member 20 is placed at the position which is apt to be affected by the using environment in the use of the image recording material of the present invention, it is possible that the resistance of the characteristic controlling member 20 can be achieved in a better manner.

As hereinafter, in the embodiment of the present invention, the characteristic controlling member 20 particularly for the control of glossiness, light resistance, heat resistance and flame retardation will be illustrated by way of exemplification successively although the present invention is not limited thereto.

Control of Glossiness

Control of glossiness is carried out in such a manner that the “glittering” of image formed on the image surface of the substrate 10 is suppressed and a visibility is improved even when seen from any angle. Examples of the characteristic controlling member 20 for controlling the glossiness are that, as shown in FIG. 1, it is constituted from a glossiness suppressing layer provided on the control surface of the substrate and that where a mechanical treatment for controlling the glossiness is applied so as to give a glossiness suppressing function to the substrate 10.

With regard to a method of a direct mechanical treatment of the control surface of the substrate 10 for controlling the glossiness, there is a method where unevenness is formed on the control surface of the substrate 10 by a mechanical means. When an unevenness is formed on the control surface of the substrate 10, scattering of light is generated on the control surface of the substrate and, when size, roughness, depth, etc. of the unevenness are changed, a desired glossiness treatment can be carried out. With regard to the above mechanical means, there may be used sand blasting method, embossing method, plasma etching method and other known mechanical surface treating methods.

A sand blasting method is a method where particles of indefinite or definite shape of organic resin, ceramic, metal, etc. are used for polishing the particles and vigorously struck on the surface of the material successively to make the surface rough. An embossing method is a method where a mold which is previously made uneven is prepared and is touched to the material and thus the unevenness of the mold is transferred onto the surface of the material. A plasma etching method is a method where an etching is carried out utilizing excited molecules, radicals, ion, etc. generated as a result of molecular dissociation by a plasma discharge. Etching proceeds by evaporation of a volatile compound which is produced by the reaction of the produced exciting species with the material.

When the characteristic controlling element 20 which suppresses the glossiness is constituted as a glossiness suppressing layer, the glossiness suppressing layer can be formed by utilizing a phase separation of polymer. It is a method where, to a resin which forms a glossiness suppressing layer, a resin which is not compatible therewith is added and a phase separation is generated during the drying and thus unevenness is generated on the surface of the layer. When type, adding amount, drying condition, etc. of the resin having no incompatibility are controlled, the state of the phase separation can be changed and thus the unevenness of the layer surface can be controlled and, as a result, glossiness of the controlling surface can be controlled.

In another embodiment where the characteristic controlling element 20 which controls the glossiness is constituted as a glossiness controlling layer, the glossiness controlling layer may be constituted at least from resin and filler. With regard to the resin, it is preferred to be constituted of a thermofusing resin which is used in an image forming material (toner) in view of affinity to the substrate, multiplicity of selection of the material, stability, cost, easiness in the preparing steps, etc. It is preferred that membrane thickness of the glossiness controlling layer is 0.01 μm to 20 μm in view of stability of the formation of the coat and, more preferably, the thickness is 0.1 μm to 5 μm so as to incorporate the filler in a stable manner and to ensure the adhesion to the substrate.

With regard to the above thermofusing resin, that which is used as a material for formation of image can be utilized without particular limitation and examples thereof include homopolymer or copolymer where one or more of the followings is/are polymerized. They are styrenes such as styrene, vinylstyrene and chlorostyrene; monoolefins such as ethylene, propylene, butylene and isobutylene; vinyl esters such as vinyl acetate, vinyl propionate, vinyl benzoate and vinyl butyrate; esters of α-unsaturated fatty acid monocarboxylic acids such as methyl acrylate, ethyl acrylate, butyl acrylate, dodecyl acrylate, octyl acrylate, phenyl acrylate, methyl methacrylate, ethyl methacrylate, butyl methacrylate and dodecyl methacrylate; vinyl ethers such as vinyl methyl ether, vinyl ethyl ether and vinyl butyl ether; vinyl ketones such as vinyl methyl ketone, vinyl hexyl ketone and vinyl isopropyl ketone; and diene monomers such as isoprene and 2-chloro butadiene. Among them, styrenes and esters of α-unsaturated fatty acid monocarboxylic acids are preferably used. It is also possible to use polyester, polyurethane resin, etc. either in a single or mixed state.

With regard to the thermofusing resin which can be used in the present invention, it is also possible to use a polyester advantageously. The polyester can be manufactured by the reaction of a polyhydroxy compound with a polybasic carboxylic acid or a reactive acid derivative thereof. Examples of the polyhydroxy compound constituting the polyester are diols such as ethylene glycol, diethylene glycol, triethylene glycol, 1,2-propylene glycol, 1,3-propylene glycol and 1,4-butanediol; adducts of bisphenol A with alkylene oxide such as hydrogenated bisphenol A, polyoxyethylene bisphenol A and polyoxypropylene bisphenol A; and other dihydric alcohol and dihydric phenol such as bisphenol A. Examples of the polybasic carboxylic acid are malonic acid, succinic acid, adipic acid, sebacic acid, alkylsuccinic acid, maleic acid, fumaric acid, methaconic acid, citraconic acid, itaconic acid, glutaconic acid, cyclohexanedicarboxylic acid, phthalic acid, isophthalic acid, terephthalic acid and other dicarboxylic acids as well as reactive acid derivatives thereof such as acid anhydride, alkyl ester and acid halide thereof. In addition to those dihydric compounds and dicarboxylic acids, it is possible to add tri- or higher hydric compound and/or tri- or higher basic carboxylic acid so as to make the polymer nonlinearized to such an extent that no substance insoluble in tetrahydroxyfuran is produced. Among those polyesters, a linear polyester resin comprising a polycondensate where bisphenol A and aromatic polycarboxylic acid are main monomer components is particularly preferably utilized. With regard to the physical properties of the polyester, the resin where softening point is within a range of from 90° C. to 150° C., glass transition temperature is within a range of from 50° C. to 100° C., number-average molecular weight is within a range of from 2,000 to 10,000, mass-average molecular weight is within a range of from 8,000 to 15,000, acid value is within a range of from 5 to 30 and hydroxyl group value is within a range of from 5 to 40 is particularly preferably used.

Further, the resin for constituting the glossiness controlling layer may be constituted from a setting resin such as thermosetting resin, photosetting resin and electron beam setting resin so as to improve its coat strength.

With regard to the thermosetting resin, that which has been known as a resin which is set (made into an insoluble form) may be adopted. Examples thereof include phenol-formaldehyde resin, urea-formaldehyde resin, melamine-formaldehyde resin, resin where acrylic polyol is set by isocyanate, resin where polyester polyol is set with melamine and resin where acrylic acid is set by melamine. It is also possible to compound a monomer which is a constituting component of thermosetting resin.

Besides the above, any thermosetting resin may be included in the thermosetting resin of the present invention so far as it is a resin which is set by a cross-linking and shows a heat resistance. With regard to such a thermosetting resin, it is preferred to use a thermosetting acrylic resin for example. A thermosetting acrylic resin is that in which a copolymer prepared by polymerization of at least one acrylate monomer or an acrylate monomer with a styrene monomer is subjected to a cross-linking with a melamine compound or a isocyanate compound. With regard to an acrylate monomer, there may be used alkyl methacrylate such as methyl methacrylate, butyl methacrylate, octyl methacrylate and stearyl methacrylate; alkyl acrylate such as ethyl acrylate, propyl acrylate, butyl acrylate and octyl acrylate; acrylonitrile; acrylamide; or an amino-containing vinyl monomer such as dimethylaminoethyl methacrylate, diethylaminoethyl methacrylate, dimethylaminoethyl acrylate and dimethylaminopropyl methacrylamide. With regard to a styrene monomer, there may be used styrene, α-methylstyrene, vinyltoluene, p-ethylstyrene, etc.

A thermosetting silicone is preferred as well. Generally, silicone resin is classified according to its molecular structure into a silicone resin having a straight-chain structure which is used as a material for silicone oil or silicone rubber and a silicone resin having a three-dimensionally cross-linked structure. Various properties such as releasing property, adhesive property, heat resistance, insulating property and chemical stability are determined by the atoms (organic molecule) bonded to silicon atom and by the degree of polymerization thereof. The setting silicone resin which can be used in the present invention is the above-mentioned silicone resin having a three-dimensionally cross-linked structure. The silicone resin having the three-dimensionally cross-linked structure is usually polymerized from a multi-functional (trifunctional, tetrafunctional) units and has a cross-linked structure.

With regard to the silicone resin having a straight-chain structure, there are the resin having a low molecular weight and being utilized as a silicone oil for insulating oil, liquid coupling, buffer oil, lubricant, hot medium, water repellent, surface treating agent, releasing agent, anti-foaming agent, etc. and silicone rubber being polymerized to an extent of molecular weight (siloxane unit) of around 5,000-10,000 by addition of vulcanizing agent or the like followed by setting upon heating. However, they are not appropriate as the setting silicone resin.

The setting silicone resin is classified according to its molecular weight unit into a silicone varnish which is soluble in organic solvents and is of relatively low molecular weight and a silicone resin having a high degree of polymerization. Further, the setting silicone resin is classified according to the setting reaction during its production stage into condensation type, addition type, radiant light type (ultraviolet ray setting type and electron beam setting type), etc. Furthermore, it is classified according to the application manner into a solvent type, a non-solvent type, etc.

Examples of the above setting condition are type of reactive group, numbers of reactive group, time for setting, temperature and irradiation energy. Examples of a method for controlling the setting condition are a method where mono- or bi-functional polydimethylsiloxane, a reaction suppressor (such as acetylene alcohol, cyclic methylvinyl cyclosiloxane and siloxane-modified acetylene alcohol) is added and a method where amount of catalyst, reaction temperature, reaction time, UV irradiation intensity, etc. are adjusted. When such setting conditions are controlled, it is possible to adjust the molecular weight of setting silicone resin, the residual amount of silanol as a reactive group, etc. and thus releasing property, hardness, adhesive property, surface hardness, transparency, chemical stability, etc. can be freely controlled.

During the stage where the above setting silicone resin is set, a strong bond is formed between the substrate and the setting silicone resin. Accordingly, the above-mentioned glossiness controlling layer has an excellent adhesive strength to the substrate and thus it does not detach from the substrate.

With regard to a photosetting resin composition, there is exemplified that where a compound having a reactive double bond such as a vinyl group in a molecule (being not limited to a low-molecular substance but covering a high-molecular one), an initiator necessary for photosetting, a protecting material for undercoat (colored layer and, in some cases, substrate layer) such as an ultraviolet absorber and, if necessary, a high-molecular substance for improving the sheet holding property such as resin are main components.

An example of the electron beam setting resin composition is that where a compound having a reactive double bond such as a vinyl group in a molecule, a protective material for undercoat (ultraviolet absorber) and, if necessary, a resin are main components. With regard to the compound having a reactive double bond in a molecule there are a mono-functional type having a (meth)acryloyl group such as methyl (meth)acrylate, ethyl (meth)acrylate, benzyl (meth)acrylate, 2-ethoxyethyl (meth)acrylate and phenoxydiethylene glycol (meth)acrylate and a poly-functional type such as 1,6-hexanediol di(meth)acrylate, neopentyl glycol di(meth)acrylate, polyethylene glycol di(meth)acrylate, polypropylene glycol di(meth)acrylate, trimethylpropane tri(meth)acrylate, pentaerythritol tri(meth)acrylate, pentaerythritol tetra(meth)acrylate and dipentaerythritol hexa(meth)acrylate. Further examples are oligomers such as polyester acrylate, polyurethane acrylate, epoxy acrylate, polyether acrylate, oligoacrylate, alkyd acrylate and polyol acrylate. Still further examples are substances having vinyl group or allyl group such as styrene monomer, α-methylstyrene, divinylbenzene, vinyl acetate, pentene, hexene and unsaturated compounds.

For further improvement of close adhesion of the glossiness controlling layer and compatibility with the undercoat protecting material, polar groups such as hydroxyl group, amino group, carboxyl group, carbonyl group and epoxy group may be introduced into such compounds.

A polymerization initiator for photosetting is added particularly in the case of setting by ultraviolet ray. Such a polymerization initiator is that which is usually called photoinitiator and, for example, that of a benzoin alkyl ether type, an acetophenone type, a benzophenone type and a thioxanthone type may be preferably used. Examples of a benzoin ether type are benzil, benzoin, benzoin methyl ether, benzoin ethyl ether and benzoin propyl ether. Examples of an acetophenone type are 2,2′-diethoxyacetophenone, 2-hydroxy-2-methylpropiophenone, p-tert-butyltrichloroacetophenone and 2,4,6-trimethylbenzoyl diphenylphosphine chloride. Examples of a benzophenone type are benzophenone, 4-chlorobenzophenone, 4,4′-dichlorobenzophenone, 3,3′-dimethyl-4-methoxybenzophenone and dibenzosuberenone. Examples of the thioxanthone type are thioxanthone, 2-chlorothioxanthone, 2-methylthioxanthone, 2-isopropylthioxanthone and 2-ethylanthraquinone.

To 100 parts by mass of the above compound having a reactive double bond, the photoinitiator is added within a range of 0.05-10 part(s) by mass or, preferably, 0.1-5 part(s) by mass. The photoinitiator used is not limited to a single substance but two or more may be jointly used.

With regard to a material for protecting the undercoat, a commercially available ultraviolet absorber or the like may be used. The material added is selected from the substances having a good stability of dispersion in the composition and being not denatured by irradiation of light. Examples thereof include the materials of a salicylic acid type such as phenyl salicylate, p-tert-butylphenyl salicylate and p-octylphenyl salicylate; a benzophenone type such as 2,4-dihydroxybenzophenone, 2-hydroxy-4-methoxybenzophenone, 2-hydroxy-4-octoxybenzophenone and 2-hydroxy-4-dodecyloxybenzophenone; a benzotriazole type such as 2-(2′-hydroxy-5′-methylphenyl)-benzotriazole, 2-(2′-hydroxy-5′-tert-butylphenyl)-benzotriazole and 2-(2′-hydrodxy-3′-tert-butyl-5′-methylphenyl)-5-chlorobenzotriazole; and a cyano acrylate type such as 2-ethylhexyl-2-cyano-3,3′-diphenyl acrylate and ethyl-2-cyano-3,3′-diphenyl acrylate.

To 100 parts by mass of the above compound having a reactive double bond, the ultraviolet absorber is added within a range of 0.01-3 part(s) by mass or, preferably, 0.1-2 part(s) by mass. In order to make the undercoat protection better, it is preferred that the ultraviolet absorber is not used solely but two or more are used jointly.

It is also possible to further add a photostabilizer of a hindered amine type and an antioxidant. A high-molecular substance selected as an agent for improvement of a holding property of sheet is that which does not have a reactive double bond to be added for improvement of a handling property (flexibility) of the sheet or for improvement of tack of the sheet surface and has a good compatibility with a compound having a double bond. For example, when a compound having a double bond is a urethane skeleton having a (meth)acryloyl group, it is possible to use acrylic resin comprising methyl methacrylate, polyester resin, urethane resin, etc. As a yardstick for the selection of a high-molecular substance, there is an SP (solubility parameter) and a combination of materials where the SP values are near. With regard to the high-molecular substance, it is possible to use fluorine resin, silicone resin, etc. in addition to the above.

In order to further improve the close adhesion of a glossiness controlling layer and the compatibility with the undercoat protecting material, a polar group such as hydroxyl group, amino group, carboxyl group, carbonyl group and epoxy group may be introduced into such a high-molecular substance. If necessary, a peroxide may be added to the glossiness controlling layer. As the peroxide, common organic peroxide may be used. More preferably, it is an organic peroxide having a decomposing temperature of 100° C. or higher in view of stability upon preservation at ambient temperature. Examples thereof include 2,2-bis(tert-butylperoxy)butane, tert-butylperoxy benzoate, di-tert-butylperoxy isophthalate, methyl ethyl ketone peroxide, dicumyl peroxide and tert-butylperoxy acetate. Adding amount of the peroxide to 100 parts by mass of the above low-molecular substance having a (meth)acryloyl group is preferably within a range of from 0.5 to 5.0 part(s) by mass. The peroxide is not limited to its sole use but two or more may be used jointly. As a result of addition of such a peroxide, the area which is hardly set by irradiation of light can be further subjected to thermosetting.

As the resin which constitutes the glossiness controlling layer, a water-soluble binder may be used in place of the above-mentioned resin. With regard to the water-soluble binder, there may be used a water-soluble high-molecular substance such as oxidized starch, phosphorylated starch, cationized starch, auto-modified starch and various modified starch, polyethylene oxide, polyacrylamide, sodium polyacrylate, sodium alginate, hydroxyethyl cellulose, methyl cellulose and polyvinyl alcohol or a derivative thereof. Depending upon the object, it is also possible that several kinds of such water-soluble polymers are mixed and used.

If necessary, small amount of coloring agent such as pigment and dye or fine particle material having a high hardness for enhancing the hardness may be further added to the glossiness controlling layer. With regard to the above coloring agent, it is possible to use pigment and dye which are used in the coating materials. Examples of the pigment are titanium oxide, iron oxide, carbon black, cyanine pigments and quinacridone pigments. Examples of the dye are azo dyes, anthraquinone dyes, indigoid dyes and stilbene dyes. It is also possible to use metal powder such as aluminum flakes, nickel powder, gold powder and silver powder as a coloring agent. It is preferred that such materials are in particles of as fine as possible. If necessary, as a material for enhancing the hardness, fine particles (volume-average particle size: 20 nm or smaller) of titanium oxide, silica, diamond, etc. may be used. When such a coloring material is added, it is preferred that the above photoinitiator is in such a type that the initiation reaction is carried out with a light having a wavelength where the absorption of the coloring agent is little.

Hereunder, combinations of materials mostly of an acrylic type will be shown. With regard to other types, the materials may be also combined similarly.

A photosetting glossiness controlling layer mainly comprising (a) an acrylic resin having a mass-average molecular weight of 20,000-1,000,000 and being solid at ambient temperature, (b) a low-molecular substance having a double bond in a molecule and (c) a photoinitiator. A photosetting glossiness controlling layer mainly comprising (a) an acrylic resin having a plurality of at least one kind of functional group selected from a group consisting of hydroxyl group, amino group and carboxyl group in a molecule, having a mass-average molecular weight within a range of from 20,000 to 1,000,000 and being solid at ambient temperature, (b) a low-molecular substance having a double bond in a molecule, (c) a photoinitiator and (e) at least one member of cross-linking agent selected from a group consisting of isocyanate cross-linking agent, melamine cross-linking agent and epoxy cross-linking agent. A photosetting glossiness controlling layer mainly comprising (f) an acrylic resin having a plurality of reactive double bonds in a molecule, having a mass-average molecular weight within a range of from 20,000 to 1,000,000 and being solid at ambient temperature, (b) a low-molecular substance having a double bond in a molecule and (c) a photoinitiator. A photosetting glossiness controlling layer mainly comprising (g) an acrylic resin having a plurality of reactive double bonds and at least one member of functional group selected from a group consisting of hydroxyl group, amino group and carboxyl group in a molecule, having a mass-average molecular weight within a range of from 20,000 to 1,000,000 and being solid at ambient temperature, (b) a low-molecular substance having a double bond in a molecular, (c) a photoinitiator and (e) at least one member of a cross-linking agent selected from a group consisting of isocyanate cross-linking agent, melamine cross-linking agent and epoxy cross-linking agent.

With regard to an electron beam setting glossiness controlling layer, those where a photoinitiator is removed from the above-mentioned combinations of photosetting glossiness controlling layer may be used for example.

The (a) which is an acrylic resin having a mass-average molecular weight within a range of from 20,000 to 1,000,000 and being solid at ambient temperature may be prepared, for example, by a copolymerization of a (meth)acrylate such as methyl (meth)acrylate, ethyl (meth)acrylate and butyl (meth)acrylate with a styrene derivative monomer or a maleic acid type monomer in the presence of a reaction initiator (such as peroxide or chain transfer agent).

The (d) which is an acrylic resin having a plurality of at least one kind of functional group selected from a group consisting of hydroxyl group, amino group and carboxyl group in a molecule, having a mass-average molecular weight within a range of from 20,000 to 1,000,000 and being solid at ambient temperature may be prepared, for example, by a copolymerization of a monomer having at least one functional group among a (meth)acrylate monomer having a carboxyl group such as (meth)acrylic acid, a (meth) acrylate monomer having a hydroxyl group such as 2-hydroxyethyl (meth)acrylate and 4-hydroxybutyl (meth)acrylate, a (meth)acrylate monomer having an amino group such as 2-aminoethyl (meth)acrylate and 3-aminopropyl (meth) acrylate with other (meth) acrylate, styrene derivative monomer or maleic acid monomer in the presence of a reaction initiator (peroxide or chain transfer agent).

The (f) which is an acrylic resin having a plurality of reactive double bonds in a molecule, having a mass-average molecular weight within a range of from 20,000 to 1,000,000 and being solid at ambient temperature and the (g) which is an acrylic resin having a plurality of reactive double bonds and at least one member of functional group selected from a group consisting of hydroxyl group, amino group and carboxyl group in a molecule, having a mass-average molecular weight within a range of from 20,000 to 1,000,000 and being solid at ambient temperature may, for example, be prepared in such a manner that a monomer having at least one functional group among a (meth)acrylic acid having a carboxyl group such as (meth) acrylic acid, a (meth)acrylate monomer having a hydroxyl group such as 2-hydroxyethyl (meth)acrylate and 4-hydroxyethyl (meth)acrylate, a (meth)acrylate monomer having an amino group such as 2-aminoethyl (meth)acrylate and 3-aminopropyl (meth)acrylate, a (meth)acrylate monomer having an aziridinyl group such as 2-(1-aziridinyl)ethyl (meth)acrylate and 2-(2-aziridinyl)butyl (meth)acrylate and a (meth)acrylate monomer having an epoxy group such as glycidyl (meth)acrylate is copolymerized with other (meth)acrylate, styrene derivative monomer or maleic acid type monomer in the presence of a reaction initiator (peroxide or chain transfer agent) and the resulting acrylate copolymer having a functional group is added to a monomer having the above functional group.

The mass-average molecular weight (Mw) of those acrylic resins (a), (d), (f) and (g) can be changed depending upon the condition for carrying out the polymerization using a reaction initiator. With regard to the acrylic resin used in the preset invention, that having a mass-average molecular weight is within a range within a range of from 20,000 to 1,000,000 is preferably used. When the mass-average molecular weight is lower than 20,000, a sufficient extension is not achieved in an elongation during the sticking operation of a sheet and there is a risk of generation of cracks while, when it is more than 1,000,000, dissolving into a solvent is hard and it is difficult to prepare a coating sheet from a photosetting resin composition. For example, when a sheet is prepared by a solvent casting, viscosity of the solvent becomes high and, therefore, only a low concentration of the resin can be subjected to a casting and thus it is difficult to make the thickness of the sheet thick.

In those acrylic resins, those where Tg (glass transition point) is preferably within a range of from −20° C. to 100° C. in view of the relation between the resistance to scratch and the hardness after setting into the sheet. However, when the surface hardness is not so high such as the hardness is 2B or lower (at 23° C.) in terms of pencil hardness or when elongation of the sheet is rarely necessary, the resin is applicable even if the hardness is outside the above range. Different kinds of acrylic resin may be jointly used provided that they are within the above molecular weight range. The above-mentioned acrylic resin (d) and (g) have a functional group such as hydroxyl group, amino group or carboxyl group and, therefore, they are cross-linked by the above cross-linking agent and thus flexibility of the sheet can be improved In the above acrylic resins (d) and (g), it is preferred that the total sum of the functional group values thereof {OH group value, NH₂ group value (NH₂: amount of NH₂ group added at the polymerization is quantitated by the same calculation as OH group or by changing NH₂group to OH group by the reaction with nitrous acid) and COOH group value (COOH value: amount of COOH group added at the polymerization is calculated as same as in the case of OH group or the value when COOH group is titrated with KOH)} are within a range of from 2 to 50. When the functional group value is less than 2, an improvement of the flexibility of the sheet cannot be expected while, when it is more than 50, a sufficient elongation of the sheet is not available. However, when elongation of the sheet is rarely necessary, the resin is applicable even outside the above range provided that the flexibility of the sheet is sufficient.

It is also possible that those acrylic resin materials are used in a form of a block copolymer where the reactive moiety of the acrylic resin is made into a form of a block or a comb. In that case, with regard to a material which is blocked with such a reactive acrylic resin material, combination with anything in addition to that which is not only an acrylic type but also styrene type, maleic acid type or imide type which are well compatible with acrylate may be used so far as it is a material which is able to block such as a material of a silicone type and a fluorine type. In that case, there are a method where the mass-average molecular weight of a material is made within the above-mentioned range and a method where the above-mentioned reactive acrylic resin is blended with such a block polymer.

Examples of the (b) which is a low-molecular substance having a double bond in a molecule contained in the above glossiness controlling layer are a mono-functional type such as methyl (meth)acrylate, ethyl (meth)acrylate, benzyl (meth)acrylate, 2-ethoxyethyl (meth)acrylate and phenoxydiethylene glycol (meth) acrylate and a poly-functional type such as 1,6-hexanediol di(meth)acrylate, neopentyl glycol di(meth)acrylate, polyethylene glycol di(meth)acrylate, polypropylene glycol di(meth)acrylate, trimethylpropane tri(meth)acrylate, pentaerythritol tri(meth)acrylate, pentaerythritol tetra(meth)acrylate and dipentaerythritol hexa(meth)acrylate.

Oligomers such as polyester acrylate, polyurethane acrylate, epoxy acrylate, polyether acrylate, oligo acrylate, alkyd acrylate and polyol acrylate are available as well. Such low-molecular substances may further have functional groups such as hydroxyl group, amino group and carboxyl group.

The above-mentioned cross-linking agent of an isocyanate type is an isocyanate compound having two or more isocyanate groups in a molecule and examples thereof include monomers such aslylene diisocyanate, diphenylmethane diisocyanate, naphthalene diisocyanate, tolidine diisocyanate, triphenylmethane triisocyanate, tris(isocyanate phenyl) thiophosphite, p-phenylene diisocyanate, xylylene diisocyanate, bis(isocyanate methyl) cyclohexane, dicyclohexylmethane diisocyanate, hexamethylene diisocyanate, lysine diisocyanate, hexamethylene diisocyanate and isophorone diisocyanate and trimethylolpropane adduct, modified product with isocyanurate, modified product with biuret, modified product with carbodiimide, modified product with urethane and modified product with allophanate of such a monomer.

The cross-linking agent of a melamine type as mentioned above is an etherized melamine resin which is prepared in such a manner that a poly-functional material having an amino group such as melamine, urea, thiourea, guanidine, guanamine, acetoguanamine, benzoguanamine, dicyandiamide and guanamine is made to react with formaldehyde and the resulting trimethylolpropane, hexamethylolmelamine, dimethylolurea dimethylolguanidine, dimethylol acetoguanamine, dimethylol benzoguanamine, etc. are made to react with alcohol such as butyl alcohol or propyl alcohol.

The cross-linking agent of an epoxy type as mentioned above is a glycidylated compound of polyhydric alcohol containing a plurality of epoxy group and is used together with a Lewis acid catalyst. With regard to the Lewis acid, that which is made into microcapsules for retarding the reaction is preferred. Examples thereof include glycidyl compounds such as diglycidyl ester of butadiene dioxide, hexadine dioxide and phthalic acid, diglycidyl ether of bisphenol A, diglycidyl ether of bisphenol F, triglycidyl ether amine of p-aminophenol, diglycidyl ether of aniline, tetraglycidyl ether of phenylenediamine, diglycidyl ether of sulfonamide and triglycidyl ether of glycerol as well as polyether-modified diglycidyl, polyester-modified diglycidyl and urethane-modified diglycidyl compound (polymer) and vinyl cyclohexene dioxide, dicyclopentadiene dioxide, etc.

Adding amount of such a cross-linking agent is preferably in such an extent that (functional group value of acrylic resin): (functional group value of cross-linking agent) is around 1:0.7-1.3. Actually however, there takes place a reaction of functional group of the acrylic resin and cross-linking agents such as a reaction between cross-linking agents of a melamine type, reaction between a cross-linking agent of a melamine type with a cross-linking agent of an epoxy type, etc. due to the reactivity of the acrylic resin used and, therefore, it is preferred that the amount is determined after carrying out a preliminary experiment.

On the other hand, although there is no limitation for the filler constituting the glossiness controlling layer, its specific examples when constituted from organic resin particles are homopolymer or copolymer which is prepared by polymerization of one or more member(s) selected from styrenes such as styrene, vinylstyrene and chlorostyrene; monoolefins such as ethylene, propylene, butylene and isobutylene; vinyl esters such as vinyl acetate, vinyl propionate, vinyl benzoate and vinyl butyrate; esters of a-unsaturated fatty acid monocarboxylic acid such as methyl acrylate, ethyl acrylate, butyl acrylate, dodecyl acrylate, octyl acrylate, phenyl acrylate, methyl methacrylate, ethyl methacrylate, butyl methacrylate and dodecyl methacrylate; vinyl ethers such as vinyl methyl ether, vinyl ethyl ether and vinyl butyl ether; vinyl ketones such as vinyl methyl ketone, vinyl hexyl ketone and vinyl isopropenyl ketone; and diene monomers such as isoprene and 2-chlorobutadiene.

Among the above, styrenes, esters of a-unsaturated fatty acid monocarboxylic acid, etc. are preferred and, when such a thermofusing resin is used as a filler, application is carried out using a solvent which does not dissolve the resin whereupon it can be used as a filler which constitutes the glossiness controlling layer. Preferably however, a thermosetting resin having a cross-linking structure prepared by addition of a cross-linking agent, etc. to such a thermofusing resin, the already-mentioned thermosetting resin, photosetting resin, electron beam setting resin, etc. which are made into fine particles are preferably used.

When filler constituting the glossiness controlling layer is constituted from inorganic fine particles, the specific examples thereof include mica, talc, silica, calcium carbonate, zinc flower, hallosite clay, kaolin, hydrochloric magnesium carbonate, quartz powder, titanium dioxide, barium sulfate, calcium sulfate and alumina.

As the shape of the filler, spherical particles are commonly used although that may be in plates, needles or indefinite.

For controlling the surface glossiness, the difference in refractive index is preferably 0.01 or more and, more preferably, it is 0.1 or more.

With regard to the volume-average particle size of the filler, it is preferred to be 10 μm or less. More preferably, it is smaller than the thickness of the glossiness controlling layer and, particularly preferably, it is within a range of from 0.01 μm to 5 μm.

Ratio by mass of the filler to the resin (filler : resin) in the glossiness controlling layer is within a range of from 0.3:1 to 3:1 and, more preferably, within a range of from 0.5:1 to 2:1. When the ratio of the filler is within the above range, there is almost no change in the glossiness before and after formation of the image and, when it is less than the above range, scattering of light lowers while, when it is more than that, formation of the glossiness controlling layer is difficult.

The image recording material of the present invention may be in such a structure that an image receiving layer is further provided so as to form the image in a good manner. Since the image receiving layer is constituted using the same resin as that used for the above-mentioned glossiness controlling layer, detailed explanation for the resin will be omitted here.

For the prevention of adhesion to or coiling around the fixing material during fixing of the image, it is preferred that the image receiving layer contains natural or synthetic wax which is a less-adhesive material to the fixing material or a releasing material such as releasing resin, reactive silicone compound and modified silicone oil.

Specific examples thereof include natural wax such as carnauba wax, beeswax, montan wax, paraffin wax and microcrystalline wax and synthetic wax such as low-molecular polyethylene wax, low-molecular polyethylene wax of an oxidized type, low-molecular polypropylene wax, low-molecular polypropylene wax of an oxidized type, higher fatty acid wax, higher fatty acid ester wax and each of them may be used solely or two or more may be used by mixing.

With regard to the releasing resin, addition of silicone resin, fluorine resin, modified silicone resin which is a modified product of silicone resin with various resin such as polyester-modified silicone resin, urethane-modified silicone resin, acrylic-modified silicone resin, polyimide-modified silicone resin, olefin-modified silicone resin, ether-modified silicone resin, alcohol-modified silicone resin, fluorine-modified silicone resin, amino-modified silicone resin, mercapto-modified silicone resin and carboxy-modified silicone resin, thermosetting silicone resin or photosetting silicone resin has been found to be useful.

It is believed that silicone-modified resin has a high affinity to toner resin as a image-forming material or to the resin particles comprising the thermofusing resin of the present invention and is appropriately mixed and dissolved each other to fuse/mix and thus it has an excellent coloring property for the pigment contained in toner and that, at the same time, due to a releasing property by a silicone resin, adhesion of the fixing material with the image recording material upon thermal fusion can be prevented.

Further, in the present invention, reactive silane compound and modified silicone oil may be mixed therewith to give a low adhesion. It has been found that the reactive silane compound reacts with an image receiving layer resin and also reacts with a modified silicone oil to act as a releasing agent which is better than the liquid lubricant inherent to the silicone oil and that, as a result of the setting reaction, the compound is strongly fixed in an image receiving layer as a releasing agent and thus the releasing agent is not detached even by a mechanical abrasion or by an extraction with a solvent.

Like the resin particles comprising the thermofusing resin, such wax and releasing resin may be made coexisting in a form of particles but, preferably, they are added to a thermofusing resin and utilized in a form of being incorporated in the resin particles in a dispersed and dissolved state in the resin particles.

Further, the image receiving layer ensures its surface resistance as an image receiving material demanded in the electrophotography system by adding a surface-active agent or an electroconductive inorganic oxide is added thereto as a charge controlling agent.

For example, when a plastic film is used as the substrate 10 for an image receiving layer, it is preferred that its surface resistance is within a range of from 1×10⁸ to 1×10¹⁵ ohms (under the condition of 25° C. and 65% RH) so as to prevent the deterioration of the image by environment such as temperature and humidity. As a method for changing the surface resistance, that can be achieved by forming surface-active agent, fine particles of electroconductive oxide, etc. on the image holding material as the above-mentioned charge controlling agent. It is also preferred to add a matting agent for improving the carrying property.

Examples of the material for the particles of the electroconductive metal oxide are ZnO, TiO, TiO₂, SnO₂, Al₂O₃, In₂O₃, SiO, SiO₂, MgO, BaO and MoO₃. Each of them may be used solely or a compounded oxide thereof may be used. It is preferred that the metal oxide further contains different elements. For example, it is preferred that Al, In, etc., Nb, Ta, etc. and Sb, Nb, halogen, etc. are contained (doped) to ZnO, TiO and SnO₂, respectively. Among them, SnO₂ doped with Sb is particularly preferred since, with a lapse of time, changes in electric conductivity is little and stability is high.

Examples of the resin having a lubricity used for the above matting agent are polyolefin such as polyethylene and fluorine resin such as polyvinyl fluoride, polyvinylidene fluoride and polytetrafluoroethylene (Teflon®). Examples of the specific material are wax of a low-molecular olefin type (such as wax of a polyethylene type), wax of a high-density polyethylene type and wax of a paraffin type or a microcrystalline type.

An example of a fluorine resin is a dispersion of polytetrafluoroethylene (PTFE). Wax of a low-molecular polyolefin type (molecular weight being usually 1,000-5,000) is preferred. Volume-average particle size of a matting agent of the above resin is preferably within a range of from 0.1 μm to 10 μm and, particularly preferably, within a range of 1 μm-5 μm. Although the more the above volume-average particle size, the better but, when it is too large, the matting agent is detached from the image receiving layer to generate a powder dropping phenomenon and thus the surface is apt to be abraded and damaged and, in addition, cloudiness (haze degree) increases. Accordingly, the above-mentioned range is preferred.

Further, content of the above matting agent is preferably 0.1-10% by mass or, more preferably, within a range of from 0.5 to 5% by mass to the above polymer. The above matting agent is preferably in a flat shape. A matting agent which is already in such a flat shape may be used; a matting agent having a relatively low softening temperature may be used followed by making into a flat shape under heating during the course of application and drying of the color material receiving layer; or it may be made into a flat shape by compressing under heating. Incidentally, it is preferred that a matting agent is projected in a convex manner from the surface of the coloring material receiving layer (a layer corresponding to a polymer layer) With regard to a matting agent, inorganic fine powder (such as SiO₂, Al₂O₃, talc or kaolin) and beady plastic powder (such as PMMA of a cross-linking type, polycarbonate, polyethylene terephthalate and polystyrene) maybe jointly used besides the above-mentioned ones.

As hereinabove, illustration was made for releasing material, charge controlling agent and matting agent added to the image receiving layer and such additives may be added to a glossiness controlling layer comprising the above-mentioned resin and filler for giving the same effect. However, in relation to the filler, it is preferred that the matting agent is added to the glossiness controlling layer within a range of from 0.1 to 10% by mass or, more preferably, within a range of from 0.5 to 5% by mass. A volume-average particle size of the matting agent added to the glossiness controlling agent is preferably within a range of from 0.1 μm to 10 μm or, particularly preferably, within a range of from 1 μm to 5 μm.

If necessary, it is possible to add various additives for plastics such as stabilizer against heating, stabilizer against oxidation, stabilizer against light, lubricant, pigment, plasticizer, cross-linking agent, agent for enhancing the anti-shock property, flame retardant, auxiliary agent for flame retardant and charge preventer to the image receiving layer and the glossiness controlling layer. It is also possible that such additives may be appropriately added to light resistance controlling layer, heat resistance controlling layer and flame retardation controlling layer as shown below.

A glossiness controlling layer at least constituted from resin and filler is formed on a substrate by the following method. Thus, at least resin and filler are dispersed in an organic solvent or in water and the dispersion in such a state is applied on or impregnated into the controlling surface of the substrate to form it. With regard to a method for application or impregnation, there are adopted commonly used methods such as blade coating method, (wire) bar coating method, spray coating method, dipping coating method, bead coating method, air knife coating method, curtain coating method and roll coating method.

With regard to drying for the formation of the above on a substrate, air drying may be applicable but, when a hot drying is carried out, drying can be easily done. As a method for drying, there may be adopted commonly used methods such as a method of placing in an oven, a method of passing into an oven and a method of contacting to a drying roller.

An image receiving layer may also be formed by the same method as that used in the above-mentioned glossiness controlling layer.

Control of Light Resistance

Control of light resistance is carried out in such a manner that light coming from the side of the controlling surface and affecting the image is shielded by a controlling surface of the substrate 10 so as to further enhance the light resistance of the image. The characteristic controlling member 20 which controls the light resistance is constituted, as shown in FIG. 1 for example, by a light resistance controlling layer provided on the controlling surface of the substrate. The light resistance controlling layer may be in a constitution comprising light resistance giving agent such as ultraviolet absorber, antioxidant and pigment or dye having an absorbing wavelength in a visible region and resin for forming a coat of such a light resistance giving agent or such a light resistance giving agent may be directly coated on the substrate itself.

As an ultraviolet absorber as a light resistance giving agent, the same ultraviolet absorber used as the above-mentioned material for the protection of undercoat maybe used.

Examples of the antioxidant as a light resistance giving agent are that of a phosphoric acid type, a sulfur type, a phenol type and a hindered amine type. Specific examples of the antioxidant of a phosphoric acid type are phosphite compounds such as trimethyl phosphite, triethyl phosphite, tri-n-butyl phosphite, trioctyl phosphite, tridecyl phosphite, tristearyl phosphite, trioleyl phosphite, tristridecyl phosphite, tricetyl phosphite, dilauryl hydrogen phosphite, diphenyl monodecyl phosphite, diphenyl mono(tridecyl) phosphite, tetraphenyl dipropylene glycol diphosphite, 4,4′-butylidene-bis[3-methyl-6-tert-(butyl)phenyl-di-tridecyl]phosphite, distearyl pentaerythritol phosphite, di-tridecyl pentaerythritol diphosphite, bisnonylphenyl pentaerythritol diphosphite, diphenyl octyl phosphite, tetra(tridecyl)-4,4′-isopropylidene diphenyl diphosphite, tris(2,3-di-tert-butylphenyl) phosphite and di(2,4-di-tert-butylphenyl) pentaerythritol diphosphite.

With regard to a trivalent organophosphorus compound of a phosphoric type antioxidant, all of the known ones may be used and, for example, those which are described in JP-B Nos. 51-40589, 51-25064, 50-35097, 49-20928, 48-22330 and 51-35193 may be used as well.

Examples of the antioxidant of a sulfur type are the following compounds. Thus, di-n-dodecyl 3,3′-thiodipropionate, dimyristyl 3,3′-thiodipropionate, di-n-octadecyl 3,3′-dithiopropionate, 2-mercaptobenzimidazole, pentaerythritol tetrakis(β-lauryl, urylthiopropionate), di-tridecyl 3,3′-thiodipropionate, dimethyl 3,3′-dithiopropionate, octadecyl thioglycolate, phenothiazine, β,β′-thiodipropionic acid, n-butyl thioglycolate, ethyl thioglycolate, 2-ethylhexyl thioglycolate, isooctyl thioglycolate, n-octyl thioglycolate, di-tert-dodecyl disulfide, n-butyl sulfide, di-n-amyl disulfide, n-dodecyl sulfide, n-octadecyl sulfide and p-thiocresol.

Examples of the antioxidant of a phenol type are the following compounds. Thus, 2,6-di-tert-butyl-p-cresol (BHT), 2,6-di-tert-butylphenol, 2,4-dimethyl-6-tert-butylphenol, butyl hydroxyphenol, 2,2′-methylenebis(4-methyl-6-tert-butylphenol), 4,4′-thiobis(3-methyl-6-tert-butylphenol), bisphenol A, DL-α-tocopherol, styrenated phenol, styrenated cresol, 3,5-di-tert-butyl hydroxybenzaldehyde, 2,6-di-tert-butyl-4-hydroxymethylphenol, 2,6-di-tert-butyl-4-hydroxymethylphenol, 2,6-di-sec-butylphenol, 2,4-di-tert-butylphenol, 3,5-di-tert-butylphenol, o-n-butoxyphenol, o-tert-butylphenol, m-tert-butylphenol, p-tert-butylphenol, o-isobutoxyphenol, o-n-propoxyphenol, o-cresol, 4,6-di-tert-butyl-3-methylphenol, 2,6-dimethylphenol, 2,3,5,6-tetramethylphenol, allyl 3-(3′,5′-di-tert-butyl-4′-hydroxyphenyl)propionate, 2,4,6-tri-tert-butylphenol, 2,4,6-trimethylpheol, 2,4,6-tris(3′,5′-di-tert-butyl-4′-hydroxybenzyl)mesitylene, 1,6-hexanediol-bis[3-(3,5-di-tert-butyl-4-hydroxyphenyl) propionate], 2,2-thio-diethylenebis[3-(3,5-di-tert-butyl-4-hydroxypheyl) propionate], 2,2-thiobis(4-methyl-6-tert-butylphenol), 3,5-di-tert-butyl-4-hydroxybenzyl phosphate, o-n-propoxyphenol, o-cresol, 4,6-di-tert-butyl-3-methylphenol, 2,6-dimethylphenol, 2,3,5,6-tetramethylphenol, stearyl 3-(3′,5′-di-tert-butyl-4′-hydroxyphenyl)propionate, 2,4,6-tri-tert-butylphenol, 2,4,6-trimethylphenol, 2,4,6-tris(3′,5′-di-tert-butyl-4′-hydroxybenzyl)mesitylene, 1,6-hexanediol bis[3-(3,5-di-tert-butyl-4-hydroxyphenyl) propionate], 2,2-thio-diethylenebis[3-(3,5-di-tert-butyl-4-hydroxypheyl) propionate], 2,2-thiobis(4-methyl-6-tert-butylphenol), 3,5-di-tert-butyl-4-hydroxybenzyl phosphate diethyl ester, 1,3,5-trimethyl-2,4,6-tris(3,5-di-tert-butyl-4-hydroxybenzylbenzene, n-octadecyl-3-(3,5-di-tert-butyl-4-hydroxybenzylbenzene, n-octadecyl-3-(3′,5′-di-tert-butyl -4-hydroxyphenyl) propionate, 2-tert-butyl-6-(3′-tert-butyl-4-hydroxyphenyl) propionate, 2-tert-butyl -6-(3′-tert-butyl-5′-methyl-2-hydroxybenzyl)-4-methyl acrylate, 4,4′-butylidene-bis (3-methyl-6-tert-butylphenol), hydroquinone, 2,5-di-tert-butylhydroquinone and tetramethylhydroquinone.

With regard to an antioxidant of a hindered amine type, the following compounds may be exemplified. Thus, bis(2,2,6,6-tetramethyl-4-piperidyl) sebacate, bis(1,2,2,6,6-pentamethyl-4-piperidyl) sebacate, 1-{2-[3-(3,5-di-tert-butyl-4-hydroxyphenyl)propionyloxy]ethyl}-4-(3,5-di-tert-butyl-4-hydroxyphenyl)propionyloxy-2,2,6,6-tetramethylpyridine, 8-benzyl-7,7,9,9-tetramethyl-3-octyl-1,3,8-triazaspiro[4,5]undecan-2,4-dione, benzoyloxy -2,2,6,6-tetramethylpyridine, 2,2,6,6-tetramethyl-4-piperidinol and tetrakis(2,2,6,6-tetramethyl-4-piperidyl/decyl) 1,2,3,4-butanetetracarboxylate.

Each of those antioxidants may be used solely or two or more thereof may be mixed and used.

With regard to pigments and dyes as light resistance giving agent having an absorption wavelength in visible range, the same pigments and dyes added to the above glossiness controlling layer may be used.

Control of Heat Resistance

Control of heat resistance is carried out by shielding the heat applied from the side of the controlling surface so as to further enhance the heat resistance of the image. As the characteristic controlling member 20 for controlling the heat resistance, it is constituted from a heat resistant controlling layer provided on the controlling surface of the substrate as shown in FIG. 1 for example. The heat resistance controlling layer may be constituted from a heat resisting resin solely or may be constituted from a heat resisting resin and a heat resisting material.

Examples of the heat resisting resin are polyamideimide resin, polyimide resin, polyphenylene sulfide resin, polyether ketone resin, polyether sulfone resin, polyether imide resin, aromatic polyester resin, silicone resin, fluorine resin, thermotropic liquid crystal polymer and copolymers thereof which have been known as engineering resins.

With regard to a heat resisting resin, there may be used the resin constituting the above-mentioned glossiness controlling resin, i.e. the same ones as the setting resins such as thermosetting resin, photosetting resin and electron beam setting resin.

The heat resisting layer may be formed by the heat resisting resin only or may be formed by the joint use of heat resisting resin and heat resisting material. As the heat resisting material, a filler constituting the above-mentioned glossiness controlling layer be used for example.

When no heat resisting material is used, the heat resisting resin may be used together with a thermoplastic resin or the like. As the thermoplastic resin, the same one as the thermoplastic resin constituting the above-mentioned glossiness controlling resin may be used for example.

Control of Flame Retardation

Control of flame retardation is carried out so as to show a resistance to burning flame applied from the side of the controlling surface. A characteristic controlling member 20 for controlling the flame retardation is constituted from a flame retardation controlling layer provided on the controlling surface of the substrate as shown in FIG. 1 for example. The flame retardation controlling layer may be constituted from a flame retarding material only or may be constituted from a flame retarding material and a resin.

As the flame retarding material, a flame retardant of an addition type such as that of a halogen type, a phosphorus type and inorganic type may be used.

Examples of the flame retardant of a halogen type are that of a bromine type such as tetrabromobisphenol A (TBA), hexabromobenzene, decabromodiphenyl ether, tetrabromoethane (TBE), tetrabromobutane (TBB) and hexabromocyclodecane (HBCD) and that of a chlorine type such as chlorinated paraffin, chlorinated polyphenyl, chlorinated polyphenyl, diphenyl chloride, perchloropentacyclodecane and chlorinated naphthalene. Better effect is achieved upon its joint use with antimony trioxide.

Main examples of the flame retardant of a phosphorus type are tricresyl phosphate, tri(β-chloroethyl) phosphate, tri (dichloropropyl) phosphate, tri (dibromopropyl) phosphate and 2,3-dibromopropyl-2,3-chloropropyl phosphate.

Examples of the inorganic flame retardant are aluminum hydroxide, magnesium hydroxide phosphate or halogenated phosphate etc., zirconium hydroxide, basic magnesium carbonate, dolomite, hydrotalcite, calcium hydroxide, barium hydroxide, tin oxide hydrate, borax and other inorganic metal compound hydrate, zinc borate, zinc metaborate, barium metaborate, zinc carbonate, magnesium-calcium carbonate, calcium carbonate, barium carbonate, magnesium oxide, molybdenum oxide, zirconium oxide, tin oxide and red phosphorus. Among them, hydrate of at least one metal compound selected from a group consisting of aluminum hydroxide, magnesium hydroxide, zirconium hydroxide, basic magnesium carbonate, dolomite and hydrotalcite and, particularly, aluminum hydroxide and magnesium hydroxide have a high flame retarding effect and are economically useful as well.

Preferred particle size of the inorganic flame retardant varies depending upon the type and, in the case of aluminum hydroxide and magnesium hydroxide for example, an average particle size is preferably not more than 20 μm or, more preferably, not more than 10 μm.

Each of those flame-retardants may be used solely or two or more thereof may be mixed and used.

When a flame retardant of a halogen type or a phosphorus type is selected as a flame retarding material, it is preferred that, to 100 parts by mass of the resin, such flame retardant is compounded within a range of from 5 to 50 parts by mass or, more preferably, within a range of from 6 to 40 parts by mass in total. When the compounding amount of the flame retardant is less than 5 parts by mass, a high flame retardation is difficult while, even when it is more than 50 parts by mass, there is not so much improvement in flame retardation but that is rather uneconomical.

When a flame retardant of an inorganic type is selected as a flame retarding material, it is preferred that, to 100 parts by mass of the resin, inorganic flame retardant is compounded within a range of from 30 to 200 parts by mass or, more preferably, within a range of from 40 to 150 parts by mass in total. When the compounding amount of the inorganic flame retardant is less than 30 parts by mass, a sufficient flame retardation is difficult by the sole use of the inorganic flame retardant and the joint use with an organic flame retardant is necessary. On the other hand, when it is more than 200 parts by mass, abrasion resistance is poor, mechanical strength such as anti-shock strength lowers, flexibility is not achieved and characteristics at low temperature are poor.

Since an inorganic flame retardant has an advantage that it does not generate toxic gas such as halogen gas upon burning, it is particularly useful as a flame retarding material.

As a resin for constituting the flame retardation controlling layer, thermoplastic resin or setting resin such as thermosetting resin, photosetting resin and electron beam setting resin constituting the above-mentioned glossiness controlling layer may be used.

As the characteristic controlling member 20 in the present invention, a single function may be given or, if necessary, many functions may be given. When many functions are given, it is possible for example that characteristic controlling layers having single function may be laminated on the controlling surface or that an additive having another function is added to a characteristic controlling layer so as to give two or more functions.

Hereunder, there will be mentioned a method where an image is formed by an electrophotography system on an un-printed substrate P having a characteristic controlling member formed by the above-mentioned method and an image receiving layer which is formed upon necessity. In such a description, an illustration is made that a characteristic controlling member is constituted from a glossiness controlling layer although the present invention is not limited thereto.

In the formation of an image on the un-printed substrate P by an electrophotography system, electrophotography charge is uniformly applied on the surface of the photosensitive material for electrophotography to charge and then the image information obtained on the surface is exposed to light whereupon a latent image of electrophotography corresponding to the exposure is formed. After that, toner is supplied from a developer to the electrophotographyic latent image on the surface of the sensitive material and thus the electrophotography latent image is visualized and developed by the toner (toner image is formed). Then the formed toner image is transferred to a surface where the image receiving layer of the un-printed substrate P is formed and, finally, the toner is fixed onto the recording material by heat or pressure whereupon an image recorded material is prepared. The image recording material of the present invention forms a reversed image on the surface where the image receiving layer of the un-printed substrate P is formed and, therefore, information of the reversed image is provided as the above image information.

At the stage of fixing, heat and pressure are applied simultaneously and thus the toner is fixed on an un-printed substrate P while, at the same time, the toner contacts the fixing material and, therefore, when the toner is lowly viscous or highly affinitive to the fixing material, it partially moves to a fixing material and remains as an off-set on the fixing material causing deterioration of the fixing material. As a result thereof, life of the fixing machine is shortened. Accordingly, it is necessary as an image recording material that the toner image has sufficient fixing property and exfoliating property from the fixing material.

On the other hand, with regard to the image recording material, it contacts the fixing material at the non-image area and thus the same property as the toner is demanded.

Thus, in the present invention, it is preferred that an image recording layer comprising a thermofusing resin is formed on one side of the image recording material. Further, a glossiness controlling layer containing a thermofusing resin or a resin such as thermosetting resin, photosetting resin or electron beam setting resin and a filler is formed on the side opposite to the side of the image recording material where the image is formed and, in addition, an additive such as a releasing agent is preferably contained in both layers and thus prevention of adhesion to the fixing material in the fixing step can be attempted. Moreover, a transfer property in an electrophotography system can be maintained by addition of a charge controlling agent to an image receiving layer.

In accordance with the present invention, a glossiness controlling layer comprising at least resin and filler is formed at least one side of the substrate while, on the opposite side, a reversed image (mirror image) of the image is formed and thus an image recording material having a desired surface glossiness can be obtained. Similarly, when other function is added instead of glossiness as a characteristic controlling member, an image recording material having a desired surface (controlling surface) property corresponding to the function can be obtained.

The image recording material of the present invention is an image recording material having excellent image qualities (color, glossiness, masking property, etc.) demanded of printed matter having a high degree of design and excellent stability upon repeated image forming steps, preparing an image-recorded material having no image defects due to scratches or foreign substances, ensuring sufficient heat resistance and light resistance even for outdoor use, and resulting in no off-set of oil-less toner. The present invention is able to provide such an image recording material, a method for preparing the same and a method for formation of images using the same.

Further, in the image recording material of the present invention, various functions in addition to glossiness such as heat resistance, light resistance, flame retardation, moisture resistance, water repellency, abrasion resistance and scratch resistance can be added/or improved on the side opposite to the side of the surface of the substrate where the image is formed. Specific examples of the image recording material where the function(s) is/are added and/or improved are a building material (decoration board, wall board, wall paper, etc.) where an inverted image is formed on the back of the image recording material while, on the surface, there is formed a silicone hard coat layer having glossiness controlling property, heat resistance, water repellency, abrasion resistance, etc. and a plate material where a pattern by the image is formed on the surface by adhesion of the above image recording material on the surface of wood or the like. In addition, an image recording material where a glossiness controlling layer is formed on the surface can be advantageously utilized as an electrically decorated film. Accordingly, the image recording material of the present invention is able to have a function which copes with various modes of use.

### EXAMPLES

Hereunder, the present invention will be more specifically illustrated by way of the Examples although the present invention is not limited thereto. Incidentally, the term “part(s)” in the Examples and the Comparative Example stands for part(s) by mass.

### Example 1

An image recording material of the present invention (Example 1) is manufactured. Hereunder, its method for the manufacture will be illustrated for each of the steps.

Preparation of Application Solution for Glossiness Controlling Layer

To 100 parts of butyl alcohol are added 10 parts of polyvinyl butyral (manufactured by Sekisui Chemical Co. Ltd.; trade name: BM-S) as a thermosetting resin, 15 parts of fine particles of polymethyl methacrylate (manufactured by Soken Chemical & Engineering Co. Ltd.; MP-1451; volume-average particle size: 0.1 μm) as a filler and 0.5 part of a charge controlling agent (manufactured by NOF; trade name: Elegan 264 WAX) followed by well stirring using a homo-mixer to prepare an application solution A for glossiness controlling layer.

Preparation of Application Solution for Image Receiving Layer

An application solution B for image receiving layer is prepared by the same composition as the above application solution A for the glossiness controlling layer except that a filler is removed from the above application solution A for glossiness controlling layer and that 0.05 part of fine particles of cross-linked polymethyl methacrylate (manufactured by Soken Chemical & Engneering Co. Ltd.; trade name: MP-150; volume-average particle size: 5 μm) is added as a matting agent.

Manufacture of Image Recording Material

The application solution A for glossiness controlling layer is applied on a PET film (manufactured by Panack; trade name: Lumirror 125 T 60) of 125 μm thickness to an extent of 30 g/m² and dried at 130° C. for 10 minutes to form a glossiness controlling layer having a thickness of 2 μm. The application solution B for image receiving layer is applied similarly to form an image receiving layer having a thickness of 2 μm on the side opposite to the side where the glossiness controlling layer is formed whereupon an image recording material (image not formed yet) having a glossiness controlling layer on one side is manufactured.

Evaluation of Property of Image Recording Material

On the manufactured image recording material (image not formed yet) is printed a color reversed image containing a solid image using a color copier manufactured by Fuji Xerox (trade name: A Color 935) to give an image recording material of Example 1 where an image is formed. In the image recording material of Example 1, fixation property of the image, image concentration after printing of the image, surface glossiness of the side of the controlling surface, heat resistance and light resistance of the image recording material itself and heat resistance of the formed image are measured as follows and thus evaluation of property is carried out.

Evaluation of fixation of the image on the image recording material is carried out using the ratio of the image concentration after exfoliation to the image concentration before exfoliation (hereinafter, abbreviated as OD ratio) [OD ratio=(image concentration before exfoliation)/(image concentration before exfoliation)] as an index where the above image fixed by the electrophotography apparatus is adhered on a solid image part of an image concentration of about 1.8 using a commercially available cellophane adhesive tape (manufactured by Nichiban; trade name: Cellotape) at the linear pressure of 300 g/cm and is exfoliated at the rate of 10 mm/second. Incidentally, as a recording medium for electrophotography, a toner fixation property in terms of OD ratio of not less than 0.8 is generally demanded.

For evaluation of image density on the image recording material, density is measured with a densitometer (manufactured by X-Rite; trade name: X-Rite 938). A density of 1.5 or more is expressed as ∘, of below 1.5 but at least 1.3 as Δ, and of below 1.3 as ×.

With regard to a surface glossiness of the image recording material, a 75 deg. specular gloss of the solid image from the controlling surface side is measured by a surface glossiness using a digital gloss meter. The evaluation is expressed as ∘, Δ and × where the glossiness is less than 20, from 20 to 40 and more than 40, respectively.

Evaluation of heat resistance of the image recording material is carried out by measuring the thermal shrinkage of the image recording material. When it is passed through the above electrophotography apparatus and an image is formed on the image recording material where the image is not yet formed, sizes in the longitudinal direction (in a proceeding direction) of the image recording material before and after the passing are measured by a tape measure and a thermal shrinkage rate is calculated by the following formula.

Thermal Shrinkage Rate (%)={[(Size before Passing)−(Size after Passing)]/[Size before Passing]}×100

The evaluation is expressed as ∘, Δ and × where the calculated thermal shrinkage ratio is less than 0.2%, 0.2% to less than 0.5% and 0.5% or more, respectively.

With regard to the heat resistance of the image, an image recording material is placed where the image surface on which a solid image is printed is upside, allowed to stand for 100 hours in a desiccator of 100° C. and the image concentrations before and after being allowed to stand are measured using the above-mentioned densitometer. The evaluation is expressed as ∘, Δ and × where the difference in the image concentrations is less than 0.1, 0.1 to less than 0.3 and 0.3 and more, respectively.

With regard to the light resistance, the material is allowed to stand at 63° C. for 100 hours in a light resistance tester in which light where wavelength of 300 nm or less is cut by a filter is irradiated on the controlling surface of the image recording material and the image concentrations before and after being allowed to stand are measured using the above densitometer. The evaluation is expressed as ∘∘, ∘, Δ and × where the difference in the image concentrations is less than 0.1, from 0.1 to 0.3, from more than 0.3 to 0.5 and more than 0.5, respectively.

Those results are described in Table 1.

### Example 2

An image recording material of the present invention (Example 2) is manufactured. Hereinafter, the manufacturing method will be illustrated for each of the steps.

Preparation of Application Solution for Glossiness Controlling Layer

To 30 parts of cyclohexanone are added 10 parts of polyester resin (manufactured by Soken Chemical & Engneering Co. Ltd.; trade name: F-1; solid content: 30% by mass) as a thermofusing resin, 6 parts of fine particles of cross-linked polymethyl methacrylate (manufactured by Soken Chemical & Engneering Co. Ltd.; MP-300F; volume-average particle size: 0.1 μm) as a filler and 0.15 part of a charge controlling agent (manufactured by NOF; trade name: Elegan 264 WAX) followed by well stirring using a homo-mixer to prepare an application solution C for glossiness controlling layer.

Preparation of Application Solution for Image Receiving Layer

An application solution D for image receiving layer is prepared by the same composition as the above application solution C for the glossiness controlling layer except that a filler is removed from the above application solution C for glossiness controlling layer and that 0.05 part of fine particles of cross-linked polymethyl methacrylate (manufactured by Soken Chemical & Engneering Co. Ltd.; trade name: MP-150; volume-average particle size: 5 μm) is added as a matting agent.

Manufacture of Image Recording Material

The application solution C for glossiness controlling layer is applied on a PET film (manufactured by Panack; trade name: Lumirror 125 U 98) of 125 μm thickness to an extent of 30 g/m² and dried at 130° C. for 10 minutes to form a glossiness controlling layer having a thickness of 2 μm. The application solution D for image receiving layer is applied similarly to form an image receiving layer having a thickness of 2 μm on the side opposite to the side where the glossiness controlling layer is formed whereupon an image recording material (image not formed yet) having a glossiness controlling layer on one side is manufactured.

Evaluation of Property of Image Recording Material

On the manufactured image recording material (image not formed yet) is formed a image by the same method as in Example 1 to prepare an image recording material of Example 2. The image recording material of Example 2 is subjected to evaluation of property by the same method as in Example 1 and the result is described in Table 1.

### Example 3

An image recording material of the present invention (Example 3) is manufactured. Hereunder, its method for the manufacture will be illustrated for each of the steps.

Preparation of Application Solution for Glossiness Controlling Layer

To 30 parts of cyclohexanone/methyl ethyl ketone (2/1% by mass) are added 10 parts of silicone resin (manufactured by GE Toshiba Silicones; trade name: Si Coat 801; solid content: 30% by mass) as a thermosetting resin, 4.5 parts of fine particles of polymethyl siloxane (manufactured by GE Toshiba Silicones; trade name: TP-105; volume-average particle size: 0.5 μm) as a filler, 0.03 part of a reactive silicone compound (manufactured by Matsumoto Chemical Industry Co. Ltd.; trade name: SI-400) and 0.03 part of modified silicone oil (manufactured by GE Toshiba Silicones; trade name: TSF 4702) as releasing agents and 0.15 part of Bionin-B144-V (trade name; manufactured by Takemoto Yushi) as a charge controlling agent followed by well stirring using a homo-mixer to prepare an application solution E for glossiness controlling layer.

Preparation of Application Solution for Image Receiving Layer

An application solution F for image receiving layer is prepared by the same composition as the above application solution E for the glossiness controlling layer except that a filler is removed from the above application solution E for glossiness controlling layer and that 0.05 part of fine particles of polymethyl silicone (manufactured by GE Toshiba Silicones; trade name: TP-145; volume-average particle size: 4.5 μm) is added as a matting agent.

Manufacture of Image Recording Material

The application solution E for glossiness controlling layer is applied on a PET film (manufactured by Panack; trade name: Lumirror 125 U 98) of 125 μm thickness to an extent of 30 g/m² and dried at 130° C. for 10 minutes to form a glossiness controlling layer having a thickness of 2 μm. The application solution F for image receiving layer is applied similarly to form an image receiving layer having a thickness of 2 μm on the side opposite to the side where the glossiness controlling layer was formed whereupon an image recording material (image not formed yet) having a glossiness controlling layer on one side is manufactured.

Evaluation of Property of Image Recording Material

On the manufactured image recording material (image not formed yet) is printed a color reversed image containing a solid image using a color copier manufactured by Fuji Xerox (trade name: A Color 935) wherefrom a fixation device is previously detached to give a sample where an image in an unfixed state is formed on an image recording material. After that, the image recording material where the image in an unfixed state is formed is subjected to evaluation for running property and coiling (exfoliation) around a fixing roll of the recording material using an oil-less fixation bench equipped with a fixation device only (an fixation off-line bench without an oil supplying system).

Running property of the image recording material is expressed as ∘ where paper jam, etc. did not take place, Δ where the paper jam rarely happens although it happens one sheet for every about ten sheets and × where forwarding of paper stops.

For coiling around the fixation roll, it is expressed as ∘ where coiling rarely happens, Δ where there is no practical problem and × where coiling to the fixation roll happens.

Then, an image is formed on the manufactured image recording material (image not formed yet) by the same manner as in Example 1 to give an image recording material of Example 3. Property of the image recording of Example 3 is evaluated by the same manner as in Example 1 and the result is described in Table 1.

### Example 4

The image receiving layer of Example 2 is applied on both surfaces of a PET film (manufactured by Panack; trade name; Lumirror 125 U 98) having a thickness of 125 μm to an extent of 30 g/m²and dried at 130° C. for 10 minutes to prepare an image recording material (image not formed yet) where image receiving layers of 2 μm thickness are formed on both sides of the substrate. Image is formed by the same manner as in Example 1 on the resulting image recording material (image not formed yet). After that, on the opposite side to the imaged surface of the image recording material, an application solution prepared by concentrating the application solution C for glossiness controlling layer of Example 2 for adjusting the viscosity is printed on the whole surface by a screen printing method followed by drying at 130° C. for 30 minutes to manufacture an image recording material of Example 4 where a glossiness controlling layer is formed on the image surface. Property of the image recording material of Example 4 is evaluated by the same manner as in Example 1 and the result is given in Table 1.

### Example 5

Preparation of Application Solution for Light Resistance Controlling Layer

To a mixture of 90 parts of methyl ethyl ketone and 10 parts of cyclohexanone are added 0.36 part of 2,6-di-tert-butyl-4-methylphenol and 0.54 part of 2-(5-methyl-2-hydroxyphenyl)benzotriazole as ultraviolet absorbers, 10 parts of polymethyl methacrylate resin as a resin, 15 parts of fine particles of polymethyl methacrylate (manufactured by Soken Chemical & Engneering Co. Ltd.; trade name: MP-300F; volume-average particle size: 0.1 μm) as a filler and 0.3 part of a charge controlling agent (manufactured by NOF; trade name: Elegan 264 WAX) followed by well stirring using a homo-mixer to prepare an application solution G for light resistance controlling layer.

Preparation of Application Solution for Image Receiving Layer

An application solution H for image receiving layer is prepared by the same composition as the above application solution G for the light resistance controlling layer except that ultraviolet absorbers and filler are removed from the above application solution G for light resistance controlling layer and that 0.045 part of fine particles of cross-linked polymethyl methacrylate (manufactured by Soken Chemical & Engneering Co. Ltd.; trade name: MP-500; volume-average particle size: 5 μm) was added as a matting agent.

Manufacture of Image Recording Material

The application solution G for light resistance controlling layer is applied on a PET film (manufactured by Panack; trade name: Lumirror 125 T 60) of 125 μm thickness to an extent of 30 g/m² and dried at 130° C. for 10 minutes to form a light resistance controlling layer having a thickness of 2 μm. The application solution H for image receiving layer is applied similarly to form an image receiving layer having a thickness of 2 μm on the side opposite to the side where the light resistance controlling layer is formed whereupon an image recording material (image not formed yet) having a light resistance controlling layer on one side is manufactured.

Evaluation of Property of Image Recording Material

Image is formed on the resulting image recording material (image formed not yet) by the same manner as in Example 1 to give an image recording material of Example 5. Property of the image recording material of Example 5 is evaluated by the same manner as in Example 1 and the result is described in Table 1.

### Example 6

Preparation of Application Solution for Heat Resistance Controlling Layer

Into 85 parts of methyl ethyl ketone are dissolved 15 parts of a prepolymerized fluorinated polyimide precursor prepared by a dehydrating ring closure of an amide acid oligomer comprising 2,2-bis (3,4-dicarboxyphenyl)hexafluoropropane dianhydride and 2,2-bis[4-(4-aminophenoxy)phenyl]-hexafluoropropane followed by treating the resulted imide oligomer of terminal amine with 2,2-bis [4-(4-maleimidophenoxy)phenyl]hexafluoropropane as a heat-resisting resin, 22.5 parts of fine particles of polymethyl methacrylate (manufactured by Soken Chemical & Engneering Co. Ltd.; trade name: MP-300F; volume-average particle size: 0.1 μm) as a filler and 0.45 part of a charge controlling agent (manufactured by NOF; trade name: Elegan 264 WAX) followed by well stirring using a homo-mixer to prepare an application solution I for heat resistance controlling layer.

Manufacture of Image Recording Material

The application solution I for heat resistance controlling layer is applied on a PET film (manufactured by Panack; trade name: Lumirror 125 T 60) of 125 μm thickness to an extent of 30 g/m² and dried at 135° C. for 60 minutes to form a heat resistance controlling layer comprising a fluorinated polyimide resin having a thickness of 2 μm. With regard to an application solution for image receiving layer, an application solution H for image receiving layer of Example 5 is used to form an image receiving layer having a thickness of 2 μm on the side opposite to the side where the heat resistance controlling layer is formed whereupon an image recording material (image not formed yet) having a heat resistance controlling layer on one side is manufactured.

Evaluation of Property of Image Recording Material

Image is formed on the resulting image recording material (image formed not yet) by the same manner as in Example 1 to give an image recording material of Example 6. Property of the image recording material of Example 6 is evaluated by the same manner as in Example 1 and the result is described in Table 1.

### Example 7

Preparation of Application Solution for Flame Retardation Controlling Layer

To 100 parts of methyl ethyl ketone are added 1.8 parts of perchloropentacyclodecane as a flame retardant, 30 parts of polyester resin (manufactured by Soken Chemical & Engneering Co. Ltd.; trade name: FF-4; solid content: 30% by mass) as a resin, 13.5 parts of fine particles of polymethyl methacrylate (manufactured by Soken Chemical & Engneering Co. Ltd.; trade name: MP-300F; volume-average particle size: 0.1 μm) as a filler and 0.2 part of a charge controlling agent (manufactured by NOF; trade name: Elegan 264 WAX) followed by well stirring using a homo-mixer to prepare an application solution J for flame retardation controlling layer.

Preparation of Application Solution for Image Receiving Layer

An application solution K for image receiving layer is prepared by the same composition as the above application solution J for the flame retardation controlling layer except that flame retardant and filler are removed from the above application solution J for flame retardation controlling layer and that 0.045 part of fine particles of cross-linked polymethyl methacrylate (manufactured by Soken Chemical & Engneering Co. Ltd.; trade name: MP-500; volume-average particle size: 5 μm) is added as a matting agent.

Manufacture of Image Recording Material

The application solution J for flame retardation controlling layer is applied on a PET film (manufactured by Panack; trade name: Lumirror 125 T 60) of 125 μm thickness to an extent of 30 g/m² and dried at 130° C. for 10 minutes to form a flame retardation controlling layer having a thickness of 2 μm. The application solution K for image receiving layer is applied similarly to form an image receiving layer having a thickness of 2 μm on the side opposite to the side where the flame retardation controlling layer is formed whereupon an image recording material (image not formed yet) having a flame retardation controlling layer on one side is manufactured.

Evaluation of Property of Image Recording Material

Image is formed on the resulting image recording material (image formed not yet) by the same manner as in Example 1 to give an image recording material of Example 7. Property of the image recording material of Example 7 is evaluated by the same manner as in Example 1 and the result is described in Table 1.

In order to further evaluate the flame retardation, the following inflammation test is carried out. Thus, as an inflammation test, an image recording material of Example 7 with 60 mm width and 150 mm length is used as a sample, the sample is attached to a U-shaped holder, kept in a horizontal state and ignited from the side of the controlling surface. The evaluation is expressed as ∘ when self-extinguishing is noted within 10 seconds, Δ when self-extinguishing is noted within 20 seconds and × when self-extinguishing is not noted within 20 seconds. The result is described in Table 1.

### Example 8

An image recording material (image not formed yet) is manufactured by the same method as in Example 5 except that the ultraviolet absorbers of Example 5 are not used. Image is formed by the same method as in Example 1 on the image recording material (image not formed yet) manufactured as such to prepare an image recording material of Example 8. Property of the image recording material of Example 8 is evaluated by the same method as in Example 1 and the result is described in Table 1.

### Example 9

An image recording material (image not formed yet) is manufactured by the same method as in Example 7 except that the flame retardant of Example 7 is not used. Image is formed by the same method as in Example 1 on the image recording material (image not formed yet) manufactured as such to prepare an image recording material of Example 9. Property of the image recording material of Example 9 is evaluated by the same method as in Example 7 and the result is described in Table 1.

### Comparative Example

An image recording material (image not formed yet) is manufactured by the same method as in Example 1 except that the glossiness controlling layer of Example 1 are not formed. Image is formed by the same method as in Example 1 on the image recording material (image not formed yet) manufactured as such to prepare an image recording material of Comparative Example. Property of the image recording material of Comparative Example is evaluated by the same method as in Example 1 and the result is described in Table 1.

TABLE 1

| | | | | | | | Heat | | |
|---|---|---|---|---|---|---|---|---|---|
| | | Image | | | | Heat | Resistance | Light | Flame |
| | Fixation | Concentration | Glossiness | Running | Exfoliation | Resistance | of Image | Resistance | Retardation |
| Example 1 | 0.90 | o | o | — | — | Δ | o | o | — |
| Example 2 | 0.92 | o | o | — | — | Δ | o | o | — |
| Example 3 | 0.86 | o | o | o | o | o | o | o | — |
| Example 4 | 0.90 | o | o | — | — | Δ | o | o | — |
| Example 5 | 0.92 | o | o | — | — | Δ | o | oo | — |
| Example 6 | 0.90 | o | o | — | — | o | o | o | — |
| Example 7 | 0.90 | o | o | — | — | Δ | o | o | o |
| Example 8 | 0.92 | o | o | — | — | Δ | o | Δ | — |
| Example 9 | 0.90 | o | o | — | — | Δ | o | o | Δ |
| Comp. Ex. | 0.90 | o | x | — | — | Δ | o | Δ | — |

According to Table 1, it is noted that each of the image recording materials of Examples 1-9 has a sufficient fixation property, an image concentration of higher than a certain degree and a high heat resistance of the image.

It is also noted that, in the image recording materials of Examples 1-9, glossiness is suppressed and is low as compared with the Comparative Example and accordingly that the visibility of the formed image is high.

According to Table 1, the image recording material of Example 3 has been found to have an excellent advantage that running property and exfoliation property are high. It has been also made clear that the image recording material of Example 5 has an excellent light resistance and that the image recording material of Example 6 has an excellent heat resistance. It has been further noted that the image recording material for Example 7 has a high flame retarding property.

In accordance with the image recording material of the present invention and a method for manufacturing the same, its manufacture is easy and, in addition, an image of high quality having sufficient heat resistance and light resistance with a good visibility even in outdoor use can be formed. Further, in accordance with the image recording material of the present invention, a characteristic controlling member is provided on the side of the substrate which is opposite to the side where an image is formed and thus it is possible to cope with various environments in actual use. Furthermore, in accordance with the present invention, when a releasing agent is contained in a glossiness controlling layer and in an image receiving layer, an off-set phenomenon can be suppressed even when an oil-less toner is used.

What is claimed is:

1. An image recording material comprising:
a substrate having transparency;
an image being formable by an electrophotography system on one side of the substrate; and
a characteristic controlling member which is provided at a side of the substrate which is opposite to the side where the image is formed.

2. The image recording material according to claim 1, wherein the characteristic controlling member comprises a glossiness controlling layer which controls glossiness.

3. The image recording material according to claim 2, wherein the glossiness controlling layer comprises resin and filler.

4. The image recording material according to claim 1, wherein the characteristic controlling member is provided at the surface of the substrate by a mechanical treatment which controls glossiness.

5. The image recording material according to claim 1, wherein the characteristic controlling member comprises a light resistance controlling layer which controls light resistance.

6. The image recording material according to claim 5, wherein the light resistance controlling layer comprises at least one material selected from the group consisting of ultraviolet absorbers, antioxidants, and pigments and dyes that have an absorption wavelength in the visible region.

7. The image recording material according to claim 1, wherein the characteristic controlling member comprises a heat resistance controlling layer which controls heat resistance.

8. The image recording material according to claim 7, wherein the heat resistance controlling layer comprises at least a heat resistant resin.

9. The image recording material according to claim 1, wherein the characteristic controlling member comprises a flame retardation controlling layer which controls flame retardation.

10. The image recording material according to claim 9, wherein the flame retardation controlling layer comprises resin and flame retardant.

11. The image recording material according to claim 1, further comprising an image receiving layer provided on the substrate and at which the image can be formed.

12. A method for producing an image recording material, the method comprising the steps of:
(a) providing a substantially transparent substrate including opposing surfaces, one surface of which is for image formation by electrophotography;
(b) forming a layer on the other surface for controlling characteristics of an image to be formed on the one surface, as viewed through the substrate;
(c) forming an image on the one surface for viewing through the substrate; and
(d) mounting the substrate with the other surface disposed for displaying the image.
